(19) United States
(12) Patent Application Publication
(10) Pub. No.: US 2026/0188832 A1
(43) Pub. Date: Jul. 2, 2026

(54) ONE-WAY PRESSURE RATED BURST DISK DEVICE FOR THERMAL RUNAWAY GAS VENTING

(71) Applicant: Wisk Aero LLC, Mountain View, CA (US)

(72) Inventors: Anthony Courville, Mountain View, CA (US); Sytse Tacoma, Christchurch (NZ); Joshua Bender, San Jose, CA (US)

(73) Assignee: Wisk Aero LLC, Mountain View, CA (US)

(21) Appl. No.: 19/431,212

(22) Filed: Dec. 23, 2025

Related U.S. Application Data
(60) Provisional application No. 63/772,322, filed on Mar. 14, 2025.
(60) Provisional application No. 63/739,279, filed on Dec. 27, 2024.

(51) Int. Cl. H01M 50/342

(52) U.S. Cl. CPC H01M 50/3425

(57) ABSTRACT

Embodiments described herein provide for thermal runaway gas venting. A device includes a one-way pressure-rated burst disk component. The one-way pressure-rated burst disk component includes a retaining ring having an internal structure, a seal, and a disk disposed between the retaining ring and the seal such that the internal structure of the retaining ring is adjacent a first surface of the disk. The retaining ring secures the disk against a panel. The internal structure of the retaining ring opposes a force applied at a second surface of the disk from an opposite side of the panel. A battery pack includes a plurality of battery modules and a venting structure between a first row of battery modules and a second row of battery modules. Each battery module includes a plurality of battery cells and a one-way pressure-rated burst disk device.

### CROSS-RELATED APPLICATIONS

This application claims priority to Provisional Patent Application No. 63/739,279, “One-Way Pressure Rated Burst Disk Device For Thermal Runaway Gas Venting,” and further claims priority to Provisional Patent Application No. 63/772,322, "One-Way Pressure Rated Burst Disk Device For Thermal Runaway Gas Venting" which are incorporated herein by reference in their entirety for all purposes.

### BACKGROUND OF THE INVENTION

Burst disks are non-reclosing pressure relief safety devices that may protect a pressure vessel, equipment, or system from over pressurization or potentially dangerous vacuum conditions. Most burst disks are sacrificial in nature due to their one-time use membranes. The membrane fails as at predetermined differential pressure. Burst disks are commonly used in petrochemical, aerospace, aviation, defense, medical, railroad, nuclear, chemical, pharmaceutical, food processing, and oil field applications.

### BRIEF SUMMARY OF THE INVENTION

Systems and methods of the present disclosure are related to thermal runway gas venting and particularly, one-way pressure-rated burst disk device for thermal runaway gas venting.

Various aircraft include individual battery modules that share a common venting system to evacuate gasses during a thermal runaway (TR) event. To comply with safety and certification requirements, any TR event must be contained at the module-level and cannot propagate to other modules. This poses the challenge in a system with a shared venting path to prevent the heat and smoke from the TR module to enter other modules through the vent. Embodiments of the present disclosure provide a venting system that can easily open under pressure in one direction to create the venting path of the TR module, while resisting pressure and high temperatures on all other modules to retain a seal.

According to one embodiment, a device for thermal runaway gas venting includes a one-way pressure-rated burst disk including a retaining ring having an internal structure, a seal, and a disk disposed between the retaining ring and the seal such that the internal structure of the retaining ring is adjacent a first surface of the disk. The retaining ring secures the disk against a panel. The internal structure of the retaining ring opposes a force applied at a second surface of the disk from an opposite side of the panel.

The device may include various optional embodiments. The internal structure of the retaining ring may include one or more spokes extending from a central hub to a circumference of the retaining ring. The internal structure of the retaining ring may include at least three spokes extending from the central hub to the circumference of the retaining ring. The device may further include a plurality of fasteners for coupling the retaining ring and the disk to the panel. The disk may include a ridge for securing the seal between the disk and the panel. The disk may include a first thickness along an outer perimeter and a second thickness along exposed surfaces of the disk. The device may include the panel. The device may further include a battery module, and an endplate of the battery module may include the one-way pressure-rated burst disk. The device may further include a sensor within the battery module. The sensor may be operable to detect a change in pressure in the battery module that is indicative of damage to the disk. The device may further include at least one hinged spring mechanism that biases the disk toward the panel. The at least one hinged spring may be operable to transition the disk from a closed configuration to an open configuration in response to a change in pressure on the opposite side of the panel.

According to another embodiment, a battery pack system includes an enclosure defining an interior volume, a plurality of battery modules positioned in the interior volume, and a venting structure positioned in the interior volume between a first row of battery modules of the plurality of battery modules and a second row of battery modules of the plurality of battery modules. Each battery module includes a plurality of battery cells and a one-way pressure-rated burst disk device for thermal runaway gas venting. The device includes a retaining ring having an internal structure. The retaining ring secures the disk device against an endplate of the battery module. The device further includes a seal and a disk disposed between the retaining ring and the seal such that the internal structure of the retaining ring is adjacent a first surface of the disk. The internal structure of the retaining ring opposes a force applied at a second surface of the disk from within the venting structure.

The system may include various optional embodiments. The internal structure may include one or more spokes extending from a central hub to a circumference of the retaining ring. The internal structure may include at least three spokes extending from the central hub to the circumference of the retaining ring. The device may further include a plurality of fasteners for coupling the retaining ring and the disk to the endplate of the battery module. The disk may include a ridge for securing the seal between the disk and the enclosure. The second surface of the disk may face toward the venting structure. The system may further include a sensor within the battery module. The sensor may be operable to detect a change in pressure in the battery module that is indicative of damage to the disk. The system may further include a sensor within the venting structure. The sensor may be operable to detect a change in pressure in the venting structure that is indicative of damage to the disk. The system may further include a wire disposed across the one-way pressure-rated burst disk device. The wire may be operable to break in response to a change in pressure in the battery module that is indicative of damage to the disk. The system may further include at least one hinged spring mechanism that biases the disk toward the venting structure. The at least one hinged spring may be operable to transition the disk from a closed configuration to an open configuration in response to a change in pressure within the venting structure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a simplified, isometric view of an example battery pack, according to at least one example.

FIG. 1B illustrates an exploded, isometric view of the battery pack of FIG. 1A, according to at least one example.

FIG. 1C is a cross-sectional top view of the battery pack of FIG. 1A, according to various embodiments of the present disclosure.

FIG. 1D is a cross-sectional, isometric view of the battery pack of FIG. 1A, according to various embodiments of the present disclosure.

FIG. 2A is an exploded view of a one-way pressure-rated burst disk device for thermal runaway gas venting, according to various embodiments of the present disclosure.

FIG. 2B is an assembled view of the one-way pressure-rated burst disk device for thermal runaway gas venting of FIG. 2A, according to various embodiments of the present disclosure.

FIG. 2C is a cross-sectional view of the one-way pressure-rated burst disk device for thermal runaway gas venting of FIG. 2B, according to various embodiments of the present disclosure.

FIG. 3A is an exemplary one-way pressure-rated burst disk device, according to various embodiments of the present disclosure.

FIG. 3B is the one-way pressure-rated burst disk device of FIG. 3A in an open configuration, according to various embodiments of the present disclosure.

FIG. 3C is a cross-sectional view of the one-way pressure-rated burst disk device of FIG. 3A, according to various embodiments of the present disclosure.

FIG. 3D is a cross-sectional view of the one-way pressure-rated burst disk device 300 of FIG. 3B, according to various embodiments of the present disclosure.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The figures and the following description relate to various embodiments by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Systems and methods of the present disclosure provide a one-way pressure-rated burst disk device for thermal runaway gas venting that provides high temperature resistance and back pressure resistance. Conventional solutions including burst membranes include features that rupture in one direction at a pressure much lower than the pressure the burst membranes can resist from the back side, however these devices rely on a polymer film that would not resist the high temperatures during a TR event, for example in a battery enclosure. Conventional TR venting systems therefore either have individual vent paths for each battery module which is heavy and space inefficient, or risk TR propagation to other battery modules through an open common vent path which is not reliable and does not provide any redundancy to prevent catastrophe. Embodiments of the present disclosure provide a one-way pressure-rated burst disk device for thermal runaway gas venting that addresses the need in the art for devices that have high temperature tolerances while providing back pressure resistance.

Although the remaining portions of the description may routinely reference lithium-ion battery cells, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to battery cells and energy storage devices used in any number of technologies that may include, without limitation, phones and mobile devices, handheld electronic devices, wearable devices, laptops and other computers, appliances, heavy machinery, transportation equipment, aeronautical and/or spacecraft electronics payloads, vehicles, as well as any other device that may use battery cells or benefit from the discussed designs. Accordingly, the disclosure and claims are not to be considered limited to any particular example discussed but can be utilized broadly with any number of devices that may exhibit some or all of the electrical or chemical characteristics of the discussed examples.

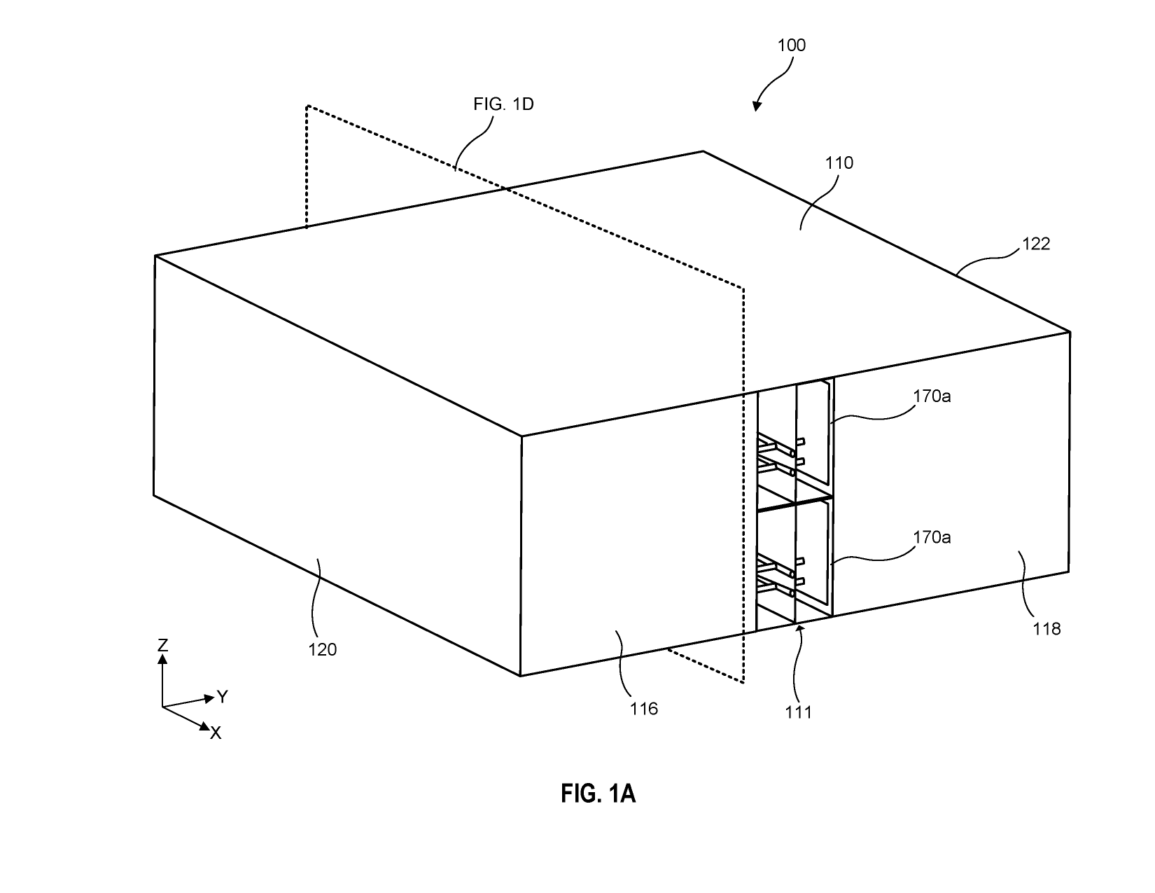

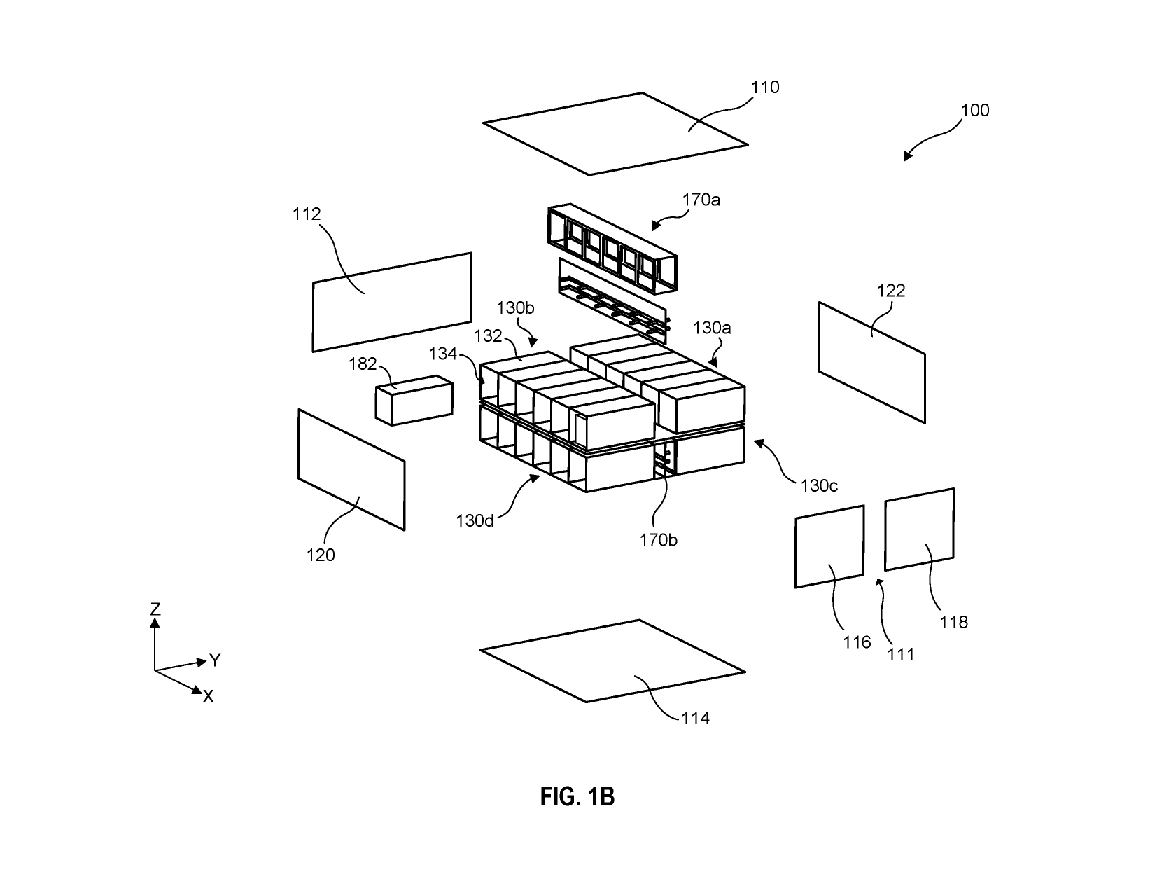

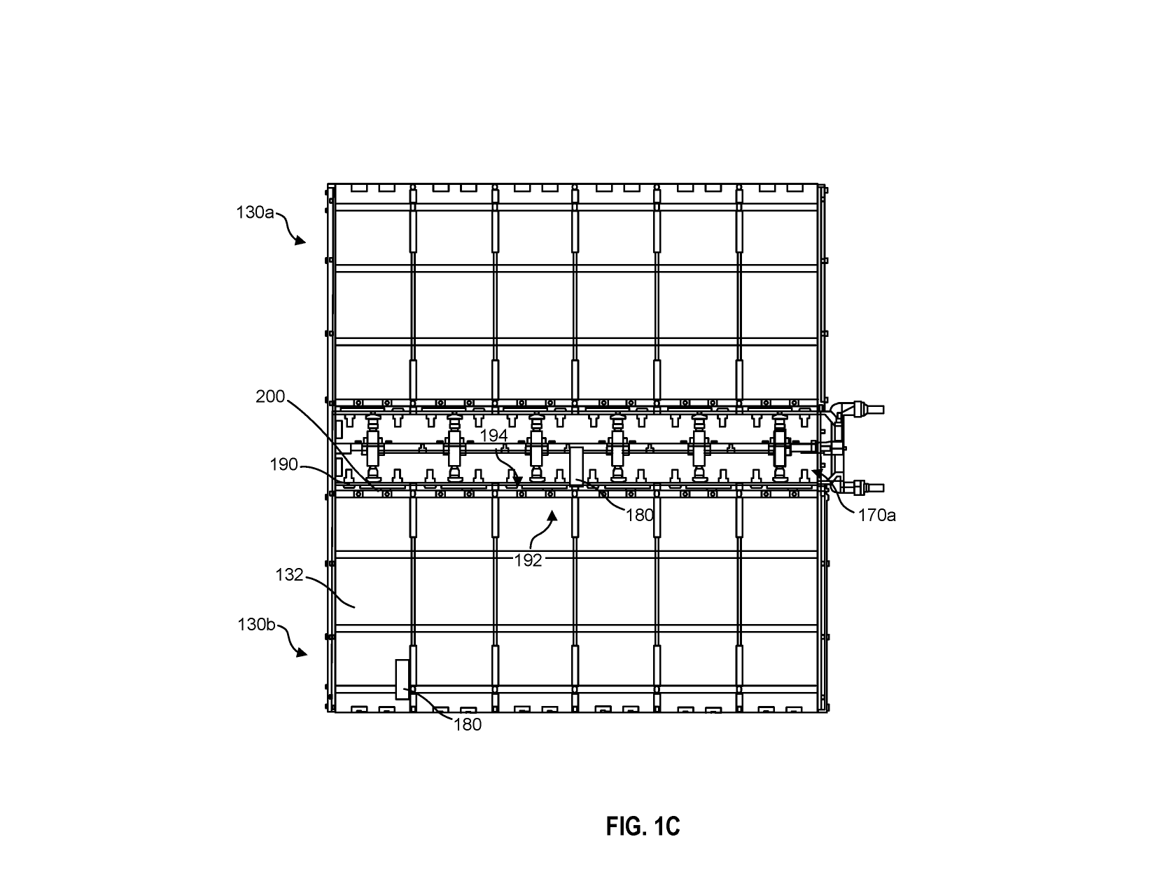

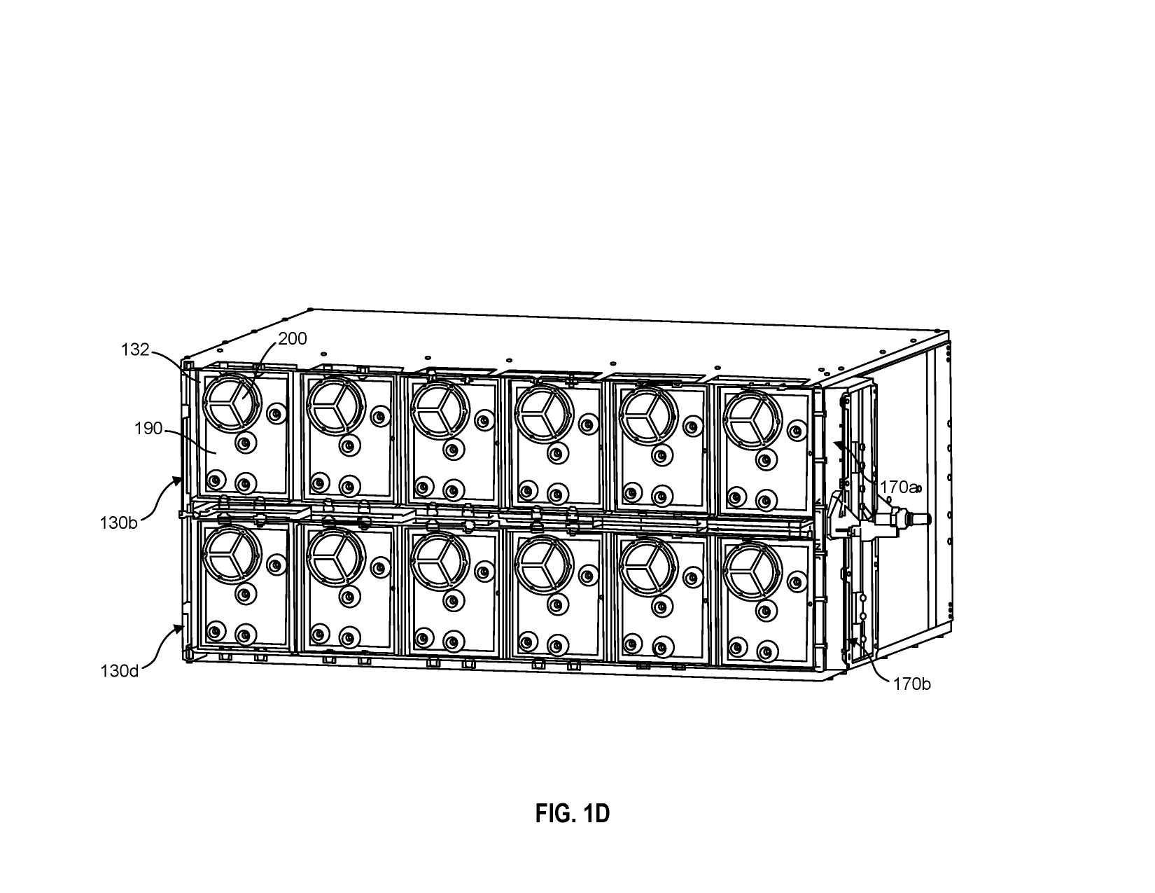

FIGS. 1A and 1B depict an example battery pack system. FIGS. 1A and 1B illustrate an exemplary battery pack 100. With specific reference to FIG. 1B, the battery pack 100 can define an enclosure formed by a first panel 110, a second panel 112, a third panel 114, a fourth panel 116, a fifth panel 118, a first sidewall 120, and a second sidewall 122. The panels 112, 114, 116, 118 may be coupled together (e.g., via welding, brazing, soldering, gluing, fastening, or the like) to define an interior volume. The panels 110, 112, 114, 116, 118 and sidewalls 120, 122 may define the enclosure to have a substantially cuboid structure, however, in other embodiments, the enclosure may have other shapes, such as being pyramid, spherical, or the like. It should be understood that, for the sake of visual clarity, the battery pack 100 may include additional components not depicted in FIGS. 1A and 1B.

The interior volume may house internal components of the battery pack 100, such as sets of battery modules 132. For example, the enclosure may house a first module row 130a of battery modules 132, a second module row 130b of battery modules 132, a third module row 130c of battery modules 132, and a fourth module row 130d of battery modules 132. Each battery module 132 may define a battery volume 134 sized and shaped to house a grouping 182 of battery cells such that each module row 130a, 130b, 130c, 130d. Each grouping 182 of battery cells can include battery cells grouped together in a stacked configuration, wound configuration, or the like. Although each module row 130a, 130b, 130c, 130d is depicted as including six battery modules 132, in other embodiments, one or more of the module rows can have more or less than six battery modules, such as four battery modules, five battery modules, seven battery modules, eight battery modules, or the like. In other embodiments, the battery modules of each module row may not be oriented in a linear row but, instead, may be oriented as a set of battery modules in a set of non-linear orientation.

The battery pack 100 can include a first venting system 170a positioned between the module rows 130a, 130b and a second venting system 170b positioned between the module rows 130c, 130d. The battery modules 132 of each of the module rows 130a, 130b, 130c, 130d may be coupled to the corresponding venting system 170a, 170b (e.g., via welding, brazing, soldering, gluing, fastening, or the like) such that an airtight seal is formed between each battery module 132 and the corresponding venting system 170a, 170b. The battery modules 132 may be coupled directly with the corresponding venting system 170a, 170b to form this airtight seal. However, in other embodiments, one or more intervening component(s) (e.g., including a gasket, seal ring, or the like) may be positioned between the battery module and the corresponding venting system to form the airtight seal. The first venting system 170a can be in fluid communication with the module rows 130a, 130b through the airtight seal such that effluent discharge may flow through the first venting system 170a and an exit opening 111 defined between the panels 116, 118 to exterior of the battery pack 100. The second venting system 170b can be in fluid communication with the module rows 130c, 130d through the airtight seal such that effluent discharge may flow through the second venting system 170b and the exit opening 111 defined between the panels 116, 118 to exterior of the battery pack 100.

FIG. 1C is a top view of the of the battery pack 100 as shown in FIGS. 1A and 1B with the first panel 110 removed. FIG. 1C illustrates the internal view of the battery pack 100 including the battery modules 132 of row 130a and the battery modules 132 of row 130b. Each endplate 190 has a first side 192 facing the interior of the battery module and a second side 194 facing the venting system 170a. A cross-sectional top view of the battery pack 100 below the venting system 170a having row 130d and row 130c visible would have similar features as those shown in FIG. 1C. As shown in FIG. 1C, each battery module 132 includes an endplate 190 having a one-way pressure-rated burst disk device 200 disposed thereon or otherwise coupled thereto, to be described in further detail below. The groupings 182 of battery cells have been removed for clarity in this view. Embodiments of the present disclosure provide isolation between battery modules 132 within a battery pack 100 such that a change in pressure in one of the battery modules 132 does not necessarily affect another battery module 132's pressure.

According to various embodiments, a sensor 180 may be disposed within the battery module 132 and/or within a venting system such as venting system 170a and/or venting system 170b. The sensor 180 may be configured to detect a change in pressure in a battery module 132 and/or within a venting system such as venting system 170a and/or venting system 170b. For example, a change in pressure may be indicative of a one-way pressure-rated burst disk device 200 bursting or another failure within a system such as the battery pack 100. In various embodiments, the sensor 180 may be configured to detect a change in pressure that is indicative of damage to the one-way pressure-rated burst disk device 200. In other embodiments, the battery module 132 and/or a venting system such as venting system 170a and/or venting system 170b may include one or more sensors for detecting other environmental monitoring parameters such as temperature, humidity, acceleration, leak detection, etc.

FIG. 1D is a cross-sectional view of the battery pack 100 as shown in FIGS. 1A and 1B. FIG. 1D illustrates the internal view of the battery pack 100 facing endplates 190 of each of the battery modules 132 in row 130b and row 130d. A cross-section of the battery pack 100 from the opposite direction (e.g., from the opposite side of the venting system 170a and the venting system 170b) facing row 130a and row 130c would have similar features as those shown and described with respect to FIG. 1D. The groupings 182 of battery cells have been removed for clarity in this view.

As shown in FIG. 1D, each endplate 190 may include a one-way pressure-rated burst disk device 200 (e.g., a one-way pressure-rated burst disk component) disposed thereon or otherwise coupled thereto, to be described in further detail below. Each battery module 132 may include a one-way pressure-rated burst disk device 200. In other embodiments, a plurality of battery modules 132, but not each of the battery modules 132, includes a one-way pressure-rated burst disk device 200. For example, every other battery module 132 may include a one-way pressure-rated burst disk device 200 in some implementations.

According to various embodiments, the one-way pressure-rated burst disk device 200 opposes forces applied from within the venting system 170a and the venting system 170b. The force may include a pressure from air or other gases flowing through or stored in the venting system 170a and the venting system 170b.

In some embodiments, in response to a battery module 132 having a TR event, the pressure within the battery module 132 bursts the respective one-way pressure-rated burst disk device 200 such that the pressure is vented into the respective venting system (e.g., venting system 170a and/or venting system 170b). An increase in pressure within the venting system 170a and the venting system 170b applies a force against the one-way pressure-rated burst disk devices 200 of other battery modules 132. The one-way pressure-rated burst disk devices 200 of other battery modules 132 resist the from the increase in pressure within the respective venting system (e.g., venting system 170a and/or venting system 170b).

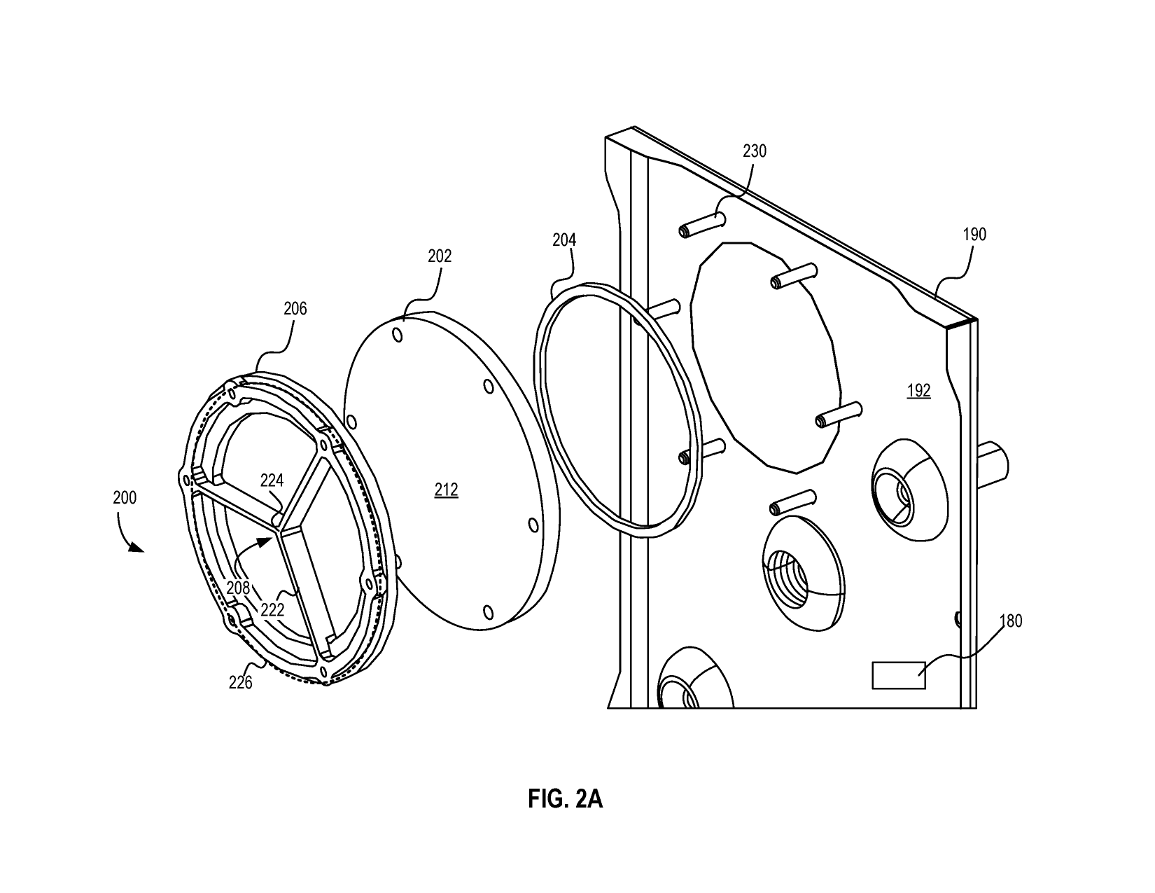

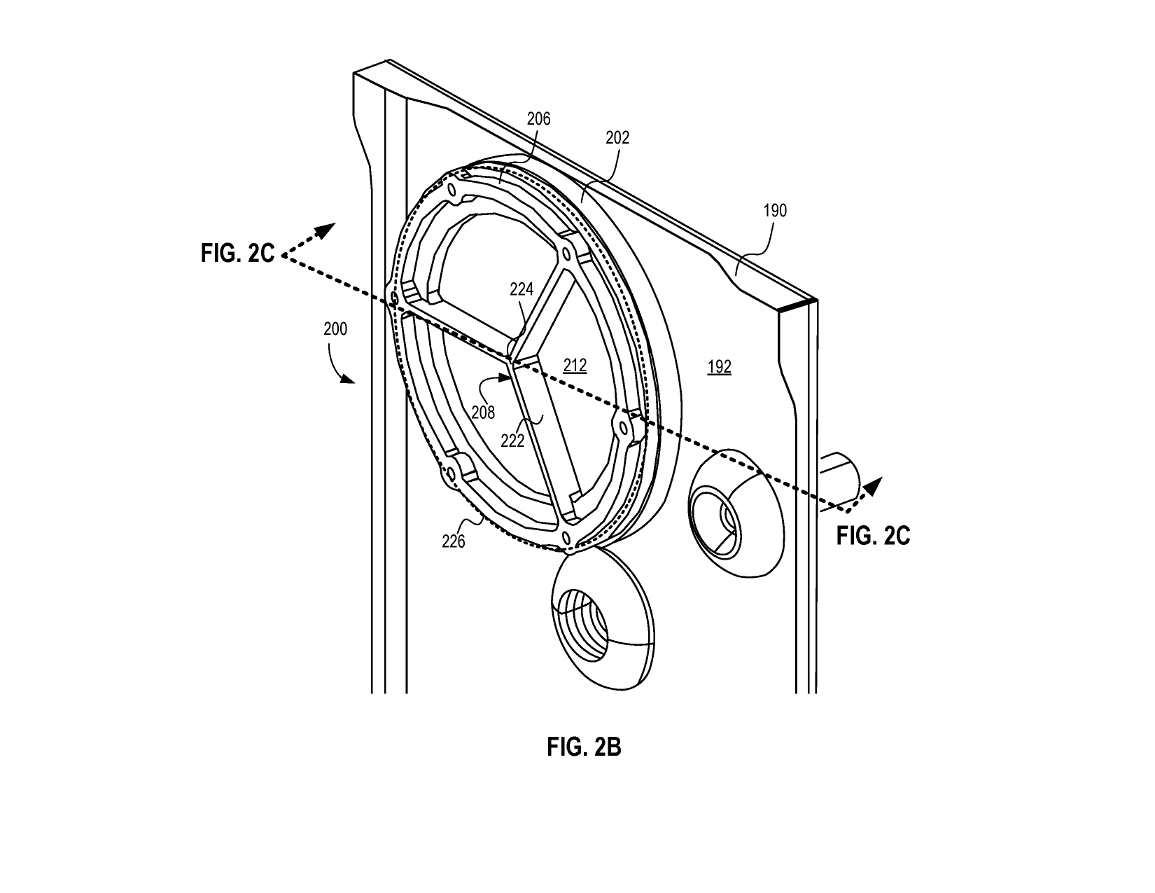

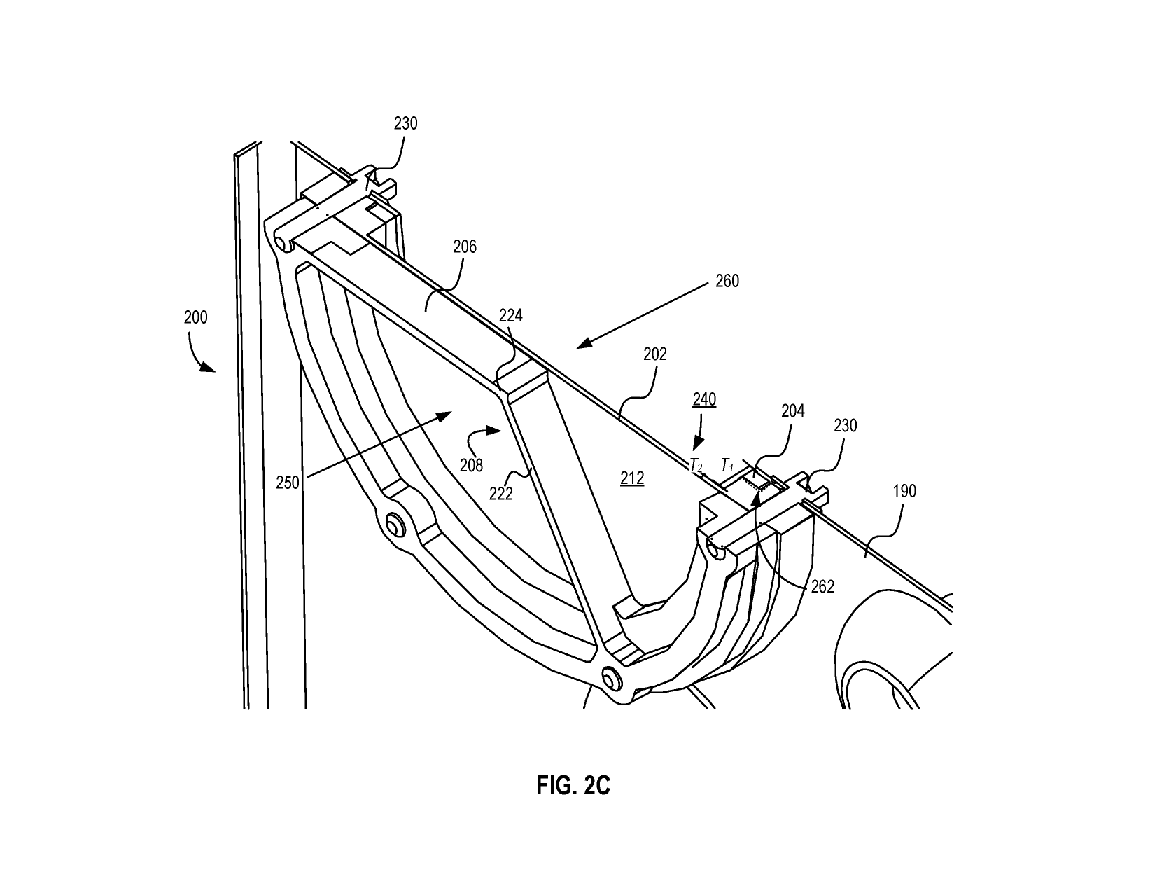

FIG. 2A is an exploded view of a one-way pressure-rated burst disk device for thermal runaway gas venting. The device 200 includes a disk 202, a seal 204, and a retaining ring 206 with an integrated support structure referred to herein as an internal structure 208. According to various embodiments, the disk 202 is a thin membrane specifically tuned to burst at a prescribed pressure based at least in part on a combination of its diameter and pressure. The disk 202 may be made of graphite. The graphite material properties ensure that disk 202 keeps its structural integrity when exposed to high temperatures.

According to some embodiments, the device 200 is coupled to or otherwise installed on an endplate 190 or the like. The endplate 190 may be interchangeably referred to herein as a panel or an enclosure. The device 200 may be disposed on any surface, including any surface within the battery pack 100 as described herein. For example, the device 200 may be installed on one or more walls of the battery modules 132 or other panels of the battery pack 100. In various embodiments, the device 200 is disposed on a first side 192 of the endplate 190 of the battery module 132 where a second side (e.g., second side 194, not visible in FIG. 2A) of the endplate 190 faces a venting system (such as venting system 170a, venting system 170b, etc.).

In various embodiments, the disk 202 is disposed between the retaining ring 206 and the seal 204 such that the internal structure 208 of the retaining ring 206 is adjacent a first surface 212 of the disk 202. The retaining ring 206 secures the disk 202 against the endplate 190 as shown in FIG. 2A such that the internal structure 208 of the retaining ring opposes a force applied at a second surface (not shown in FIG. 2A) of the disk 202 from an opposite side (e.g., second side 194, not visible in FIG. 2A) of the endplate 190. The second surface of the disk 202 faces toward the venting structure described herein.

In various embodiments, the retaining ring 206 holds onto the disk 202 and the seal 204 to provide a hermetic seal under normal conditions. The seal 204 may sit between the disk 202 and the endplate 190 on which the device 200 is installed to provide a hermetic seal in the event where the device 200 is exposed to back pressure. The seal 204 may include a high-temperature rated silicone foam to resist the high temperatures of TR and keep the seal’s 204 sealing properties. The internal structure 208 of the retaining ring 206 may include a three-pointed star that sits flush against the inside surface 212 of the disk 202 such that when disk 202 experiences back pressure, the disk 202 transfers loads into the internal structure 208 with minimal deflection. The internal structure 208 minimizes strain on the disk 202 and provides the high back pressure resistance of the device 200. The retaining ring 206 may be manufactured out of computer numerical control (CNC) machined titanium to provide the strength, high temperature resistance, and low weight for the device 200.

In some embodiments, and as shown in FIG. 2A, the internal structure 208 of the retaining ring 206 includes one or more spokes 222 extending from a central hub 224 to a circumference 226 of the retaining ring 206. The central hub 224 may refer to a central point from which each spoke 222 extends. As shown in FIG. 2A, the internal structure 208 includes three spokes. In various other embodiments, the internal structure 208 may include four spokes 222, five spokes 222, 6 spokes 222, etc. In at least some embodiments, not all of the spokes 222 extend to the circumference 226 of the retaining ring 206. In further embodiments, the internal structure 208 may include other shapes such as an S-shape that extends across the circumference 226 of the retaining ring 206. In another example, the internal structure 208 may include a triangle that contacts the circumference 226 of the retaining ring 206 at each of the three points.

According to various embodiments, a sensor 180 may be disposed on the endplate 190. In other embodiments, the sensor 180 may be disposed within the battery module 132 and/or within a venting system such as venting system 170a and/or venting system 170b. The sensor 180 may be configured to detect a change in pressure in a battery module 132 and/or within a venting system such as venting system 170a and/or venting system 170b. In various embodiments, the sensor 180 may be configured to detect a change in pressure that is indicative of damage to the one-way pressure-rated burst disk device 200. In other embodiments, the sensor 180 may include one or more sensors for detecting other environmental monitoring parameters such as temperature, humidity, acceleration, leak detection, etc. In some embodiments, the sensor 180 may include a wire disposed across the one-way pressure-rated burst disk device 200. The wire may be operable to break in response to a change in pressure in the battery module that is indicative of damage to the disk 202 and/or the one-way pressure-rated burst disk device 200.

FIG. 2B is an assembled view of the one-way pressure-rated burst disk device 200 for thermal runaway gas venting of FIG. 2A. As shown in FIG. 2B, the device 200 is coupled to or otherwise installed on the endplate 190. The retaining ring 206 maintains the position of the disk 202 and the seal 204 (not visible in this view) relative to the endplate 190. The internal structure 208 of the retaining ring 206 is adjacent to the surface 212 of the disk 202 to provide pressure against pressure applied to an opposite surface of the disk 202. For example, the opposite surface of the disk 202 faces the interior of the endplate 190 such that any pressure build up in the endplate 190 interfaces with the opposite surface of the disk 202.

FIG. 2C is a cross-sectional view of the one-way pressure-rated burst disk device for thermal runaway gas venting as shown in FIG. 2B. As shown in FIG. 2C, the device 200 is coupled to or otherwise installed on the endplate 190. The device 200 is coupled to the endplate 190 via one or more fastening mechanisms 230. The fastening mechanisms 230 may include any of twist and lock fasteners, screws, nails, adhesive, washers, anchors, rivets, etc., or any combination thereof. The retaining ring 206, in combination with the fastening mechanisms 230, maintain the position of the disk 202 and the seal 204 relative to the endplate 190. The internal structure 208 of the retaining ring 206 is adjacent to the surface 212 of the disk 202 to provide pressure against pressure applied to an opposite surface 240 of the disk 202. According to some embodiments, the opposite surface 240 of the disk 202 faces the interior of a venting system or the like, such that any pressure build up interfaces with the opposite surface 240 of the disk 202. The internal structure 208 provides a force in direction 250 as applied to the disk 202 opposite from a force in direction 260 from within the venting system or other compartment. Accordingly, the retaining ring 206, especially the internal structure 208, provide back pressure resistance capabilities that are not provided by conventional burst discs.

According to various embodiments, and as shown in FIG. 2C, the disk 202 includes a ridge 262 for securing the seal 204 between the disk 202 and the endplate 190. The height and/or the width of the ridge 262 (e.g., how much of an indent into the disk 202) may tuned for various applications. Furthermore, the disk 202 may include a first thickness T₁ along an outer perimeter of the disk 202 and a second thickness T₂ along exposed surfaces of the disk 202. For example, an outer portion of the disk 202 is disposed between the retaining ring 206 and the endplate 190 and an inner portion is exposed through an aperture in the endplate 190 to an outer environment. The exposed inner area may be characterized by a thinner thickness relative to the outer portion that secured the disk 202 in place against the endplate 190.

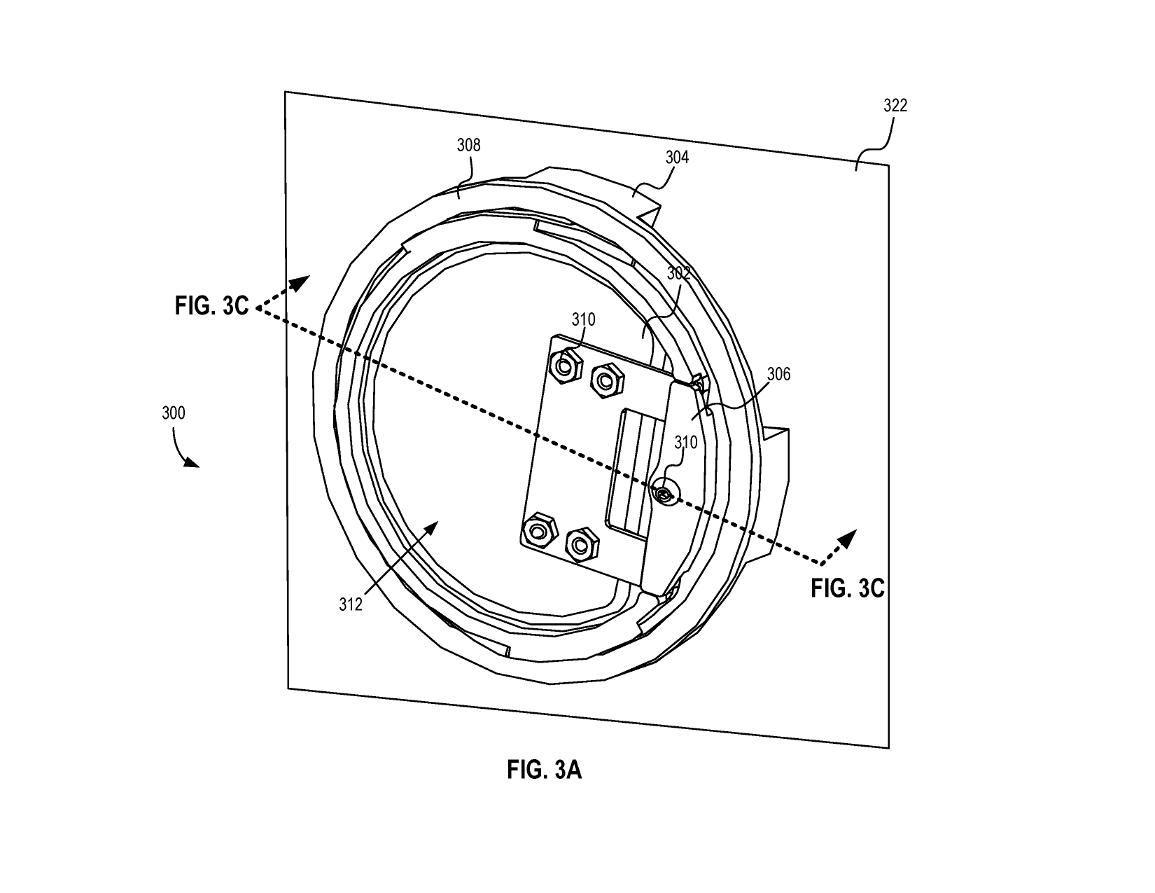

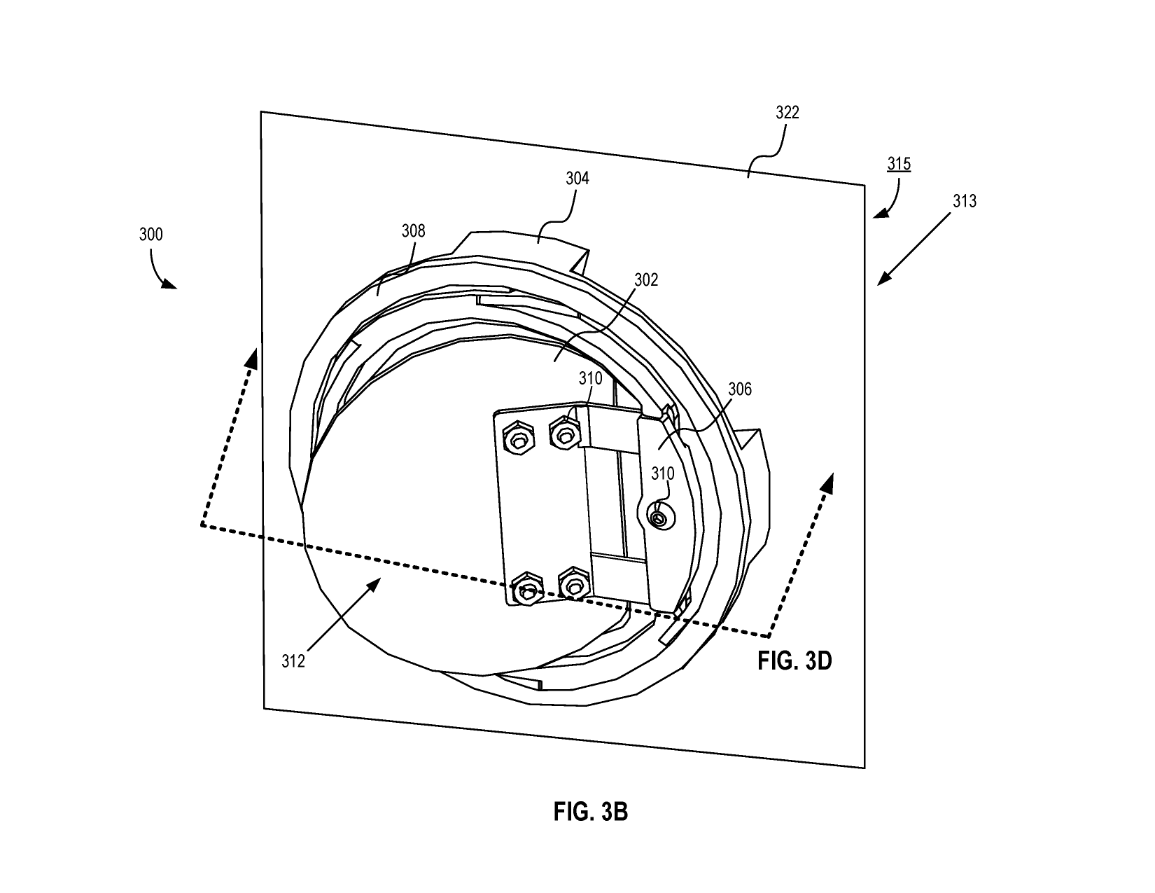

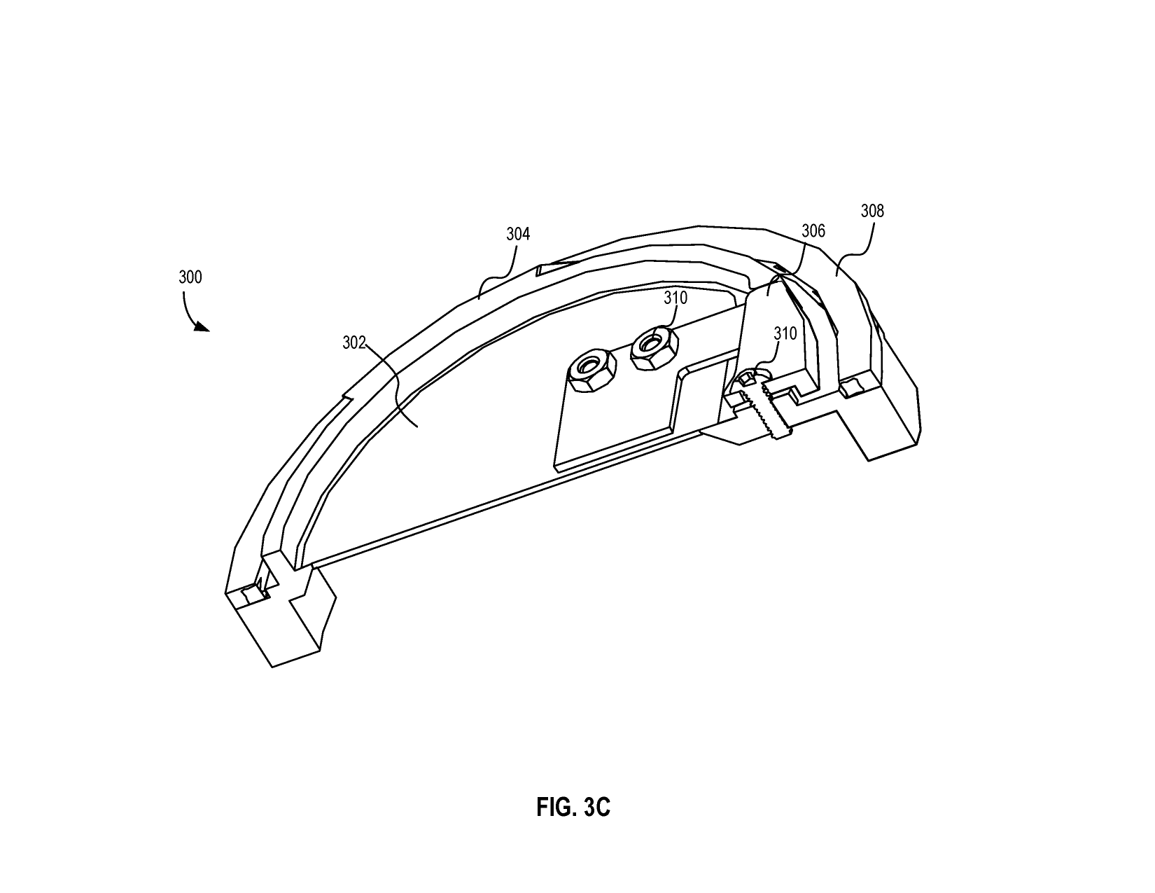

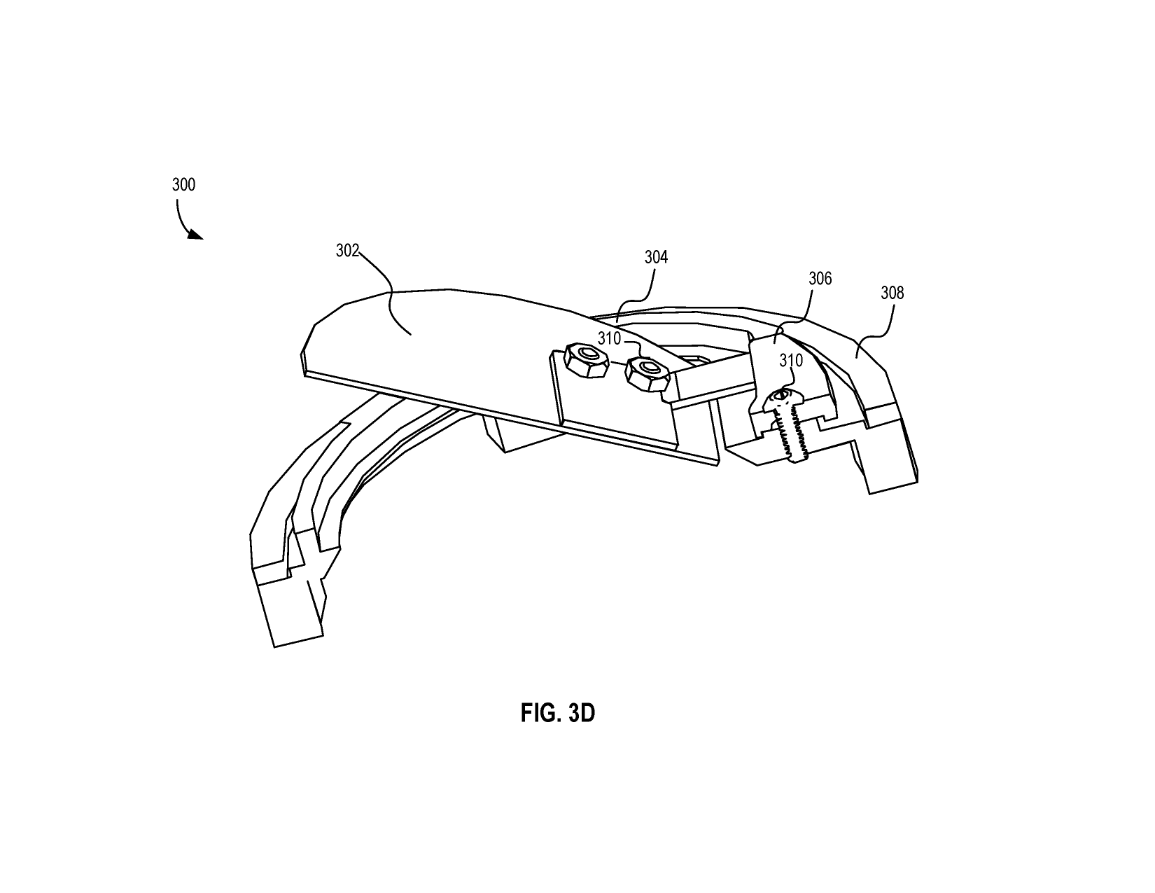

FIG. 3A is an exemplary one-way pressure-rated burst disk device 300. FIG. 3B is the one-way pressure-rated burst disk device 300 of FIG. 3A in an open configuration. FIG. 3C is a cross-sectional view of the one-way pressure-rated burst disk device 300 of FIG. 3A. Device 300 may be another embodiment of a one-way pressure-rated burst disk device. The device 300 includes a disk 302 coupled to a retaining ring 306 via a hinged spring mechanism 304. The hinged spring mechanism 304 may include a spring or the like that biases the disk 302 toward a panel and/or a venting structure. The hinged spring mechanism 304 may be coupled to the disk 302 and/or to the retaining ring 306 via one or more fasteners 310 including any of the types of fasteners described herein.

According to various embodiments, the hinged spring mechanism 304 biases the disk 302 toward an endplate 322 in a direction 312. For example, the hinged spring mechanism 304 biases the disk 302 toward a venting structure on the opposite side of the endplate 322. The panel may be an endplate such as endplate 190 described with respect to other figures. The venting structure may be a venting system 170a and/or a venting system 170b as described in detail above. According to various embodiments, the disk 302 includes steel or the like such that the disk 302 does not burst but rather transitions from a closed configuration (as shown in FIG. 3A) to an open configuration in response to a change in pressure within the venting structure and/or within the battery module or other container having the one-way pressure-rated burst disk device 300 disposed therein. Accordingly, the disk 302 is operable to transition from a closed configuration to an open configuration as shown in FIG. 3B.

FIG. 3B is the one-way pressure-rated burst disk device 300 of FIG. 3A in an open configuration where pressure is applied in a direction 313 from an opposite side 315 of the endplate 322. To transition the one-way pressure-rated burst disk device 300, the pressure in direction 313 (e.g., from within a venting structure or the like) overcomes the biasing force of the hinged spring mechanism 304. FIG. 3D is a cross-sectional view of the one-way pressure-rated burst disk device 300 of FIG. 3B.

According to some embodiments, the device 300 is coupled to or otherwise installed on a panel, an endplate, or the like. The device 300 may be disposed on any surface, including any surface within the battery pack 100 as described herein. For example, the device 300 may be installed on one or more walls of the battery modules 132 or other panels of the battery pack 100. In various embodiments, the retaining ring 308 is further secured to a surface by a secondary retaining ring 308 and a seal (not visible in FIG. 3A).

Embodiments of the present disclosure provide both the high temperature resistance and the back pressure resistance capabilities. Devices as described herein may be fully passive in nature, meaning that there are no required active systems such as sensors, actuators, or electronics. This provides a high level of reliability and eliminates potential failure modes which is important for a safety critical device such as this invention. Embodiments of the present disclosure may be used in any battery venting system where a modular battery pack utilizes a common venting path for more than one module. Accordingly, various embodiments described herein may be used in any industrial or commercial application using lithium-ion batteries where thermal runaway is a major safety risk. Further embodiments may be applied to other industrial applications where a process must be able to open a seal under a prescribed pressure condition in one direction while resisting high pressures and/or temperature in the opposite direction.

Various embodiments of the present disclosure may be applied to other applications that use burst disks. Exemplary applications include any large battery modules, systems having common gas collecting compartments, grid systems. Features of the one-way pressure-rated burst disk device as described herein may be tuned for these applications. For example, the height and width of the ridge within the disk, the thickness of different portions of the disk, the ratio of thicknesses, the number of spokes of the retaining ring, etc., may be tuned for different applications. For example, for higher pressure systems, more than three spokes may be used in the internal structure of the retaining ring to increase the support area of the one-way pressure-rated burst disk device and the pressure that the one-way pressure-rated burst disk device can withstand.

### Examples

Example 1: A device for thermal runaway gas venting includes a one-way pressure-rated burst disk including a retaining ring having an internal structure, a seal, and a disk disposed between the retaining ring and the seal such that the internal structure of the retaining ring is adjacent a first surface of the disk. The retaining ring secures the disk against a panel. The internal structure of the retaining ring opposes a force applied at a second surface of the disk from an opposite side of the panel.

Example 2: A device according to example 1, wherein the internal structure of the retaining ring comprises one or more spokes extending from a central hub to a circumference of the retaining ring.

Example 3: A device according to any of examples 1-2, wherein the internal structure of the retaining ring includes at least three spokes extending from the central hub to the circumference of the retaining ring.

Example 4: A device according to any of examples 1-3, further including a plurality of fasteners for coupling the retaining ring and the disk to the panel.

Example 5: A device according to any of examples1-4, wherein the disk includes a ridge for securing the seal between the disk and the panel.

Example 6: A device according to any of examples 1-5, wherein the disk includes a first thickness along an outer perimeter and a second thickness along exposed surfaces of the disk.

Example 7: A device according to any of examples 1-6, further including the panel.

Example 8: A device according to any of examples 1-7, further including a battery module and an endplate of the battery module comprising the one-way pressure-rated burst disk.

Example 9: A device according to example 8, further including a sensor within the battery module, the sensor being operable to detect a change in pressure in the battery module that is indicative of damage to the disk.

Example 10: A device according to any of examples 1-9, further including at least one hinged spring mechanism that biases the disk toward the panel, wherein the at least one hinged spring is operable to transition the disk from a closed configuration to an open configuration in response to a change in pressure on the opposite side of the panel.

Example 11: A battery pack system includes an enclosure defining an interior volume, a plurality of battery modules positioned in the interior volume, and a venting structure positioned in the interior volume between a first row of battery modules of the plurality of battery modules and a second row of battery modules of the plurality of battery modules. Each battery module includes a plurality of battery cells and a one-way pressure-rated burst disk device for thermal runaway gas venting. The device includes a retaining ring having an internal structure. The retaining ring secures the disk device against an endplate of the battery module. The device further includes a seal and a disk disposed between the retaining ring and the seal such that the internal structure of the retaining ring is adjacent a first surface of the disk. The internal structure of the retaining ring opposes a force applied at a second surface of the disk from within the venting structure.

Example 12: A system according to example 11, wherein the internal structure includes one or more spokes extending from a central hub to a circumference of the retaining ring.

Example 13: A system according to example 12, wherein the internal structure comprises at least three spokes extending from the central hub to the circumference of the retaining ring.

Example 14: A system according to any of examples 11-13, further including a plurality of fasteners for coupling the retaining ring and the disk to the endplate of the battery module.

Example 15: A system according to any of examples 11-14, wherein the disk includes a ridge for securing the seal between the disk and the enclosure.

Example 16: A system according to any of examples 11-15, wherein the second surface of the disk faces toward the venting structure.

Example 17: A system according to any of examples 11-16, further including a sensor within the battery module, the sensor being operable to detect a change in pressure in the battery module that is indicative of damage to the disk.

Example 18: A system according to any of examples 11-17, further including a sensor within the venting structure, the sensor being operable to detect a change in pressure in the venting structure that is indicative of damage to the disk.

Example 19: A system according to any of examples 11-18, further including a wire disposed across the one-way pressure-rated burst disk device, the wire being operable to break in response to a change in pressure in the battery module that is indicative of damage to the disk.

Example 20: A system according to any of examples 11-19, further including at least one hinged spring mechanism that biases the disk toward the venting structure, wherein the at least one hinged spring is operable to transition the disk from a closed configuration to an open configuration in response to a change in pressure within the venting structure.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

Upon reading this disclosure, those of skill in the art will appreciate still additional alternative designs for the system. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in any claims drawn to the subject matter herein.

What is claimed is:

1. A device for thermal runaway gas venting comprising:
a one-way pressure-rated burst disk comprising:
a retaining ring having an internal structure;
a seal; and
a disk disposed between the retaining ring and the seal such that the internal structure of the retaining ring is adjacent a first surface of the disk,
wherein the retaining ring secures the disk against an endplate,
wherein the internal structure of the retaining ring opposes a force applied at a second surface of the disk from an opposite side of the panel.

2. The device of claim 1, wherein the internal structure of the retaining ring comprises one or more spokes extending from a central hub to a circumference of the retaining ring.

3. The device of claim 1, wherein the internal structure of the retaining ring comprises an S-shaped structure or a triangular shaped central structure that extends across the retaining ring.

4. The device of claim 1, further comprising a plurality of fasteners for coupling the retaining ring and the disk to the panel.

5. The device of claim 1, wherein the disk comprises a ridge for securing the seal between the disk and the panel.

6. The device of claim 1, wherein the disk comprises a first thickness along an outer perimeter and a second thickness along exposed surfaces of the disk.

7. The device of claim 1, further comprising the panel.

8. The device of claim 1, further comprising a battery module and an endplate of the battery module comprising the one-way pressure-rated burst disk.

9. The device of claim 8, further comprising a sensor within the battery module, the sensor being operable to detect a change in pressure in the battery module that is indicative of damage to the disk.

10. The device of claim 1, further comprising at least one hinged spring mechanism that biases the disk toward the panel, wherein the at least one hinged spring is operable to transition the disk from a closed configuration to an open configuration in response to a change in pressure on the opposite side of the panel.

11. A battery pack system comprising:
an enclosure defining an interior volume;
a plurality of battery modules positioned in the interior volume; and
a venting structure positioned in the interior volume between a first row of battery modules of the plurality of battery modules and a second row of battery modules of the plurality of battery modules, wherein each battery module comprises a plurality of battery cells and a one-way pressure-rated burst disk device for thermal runaway gas venting comprising:
a retaining ring having an internal structure, wherein the retaining ring secures the disk device against an endplate of the battery module;
a seal; and
a disk disposed between the retaining ring and the seal such that the internal structure of the retaining ring is adjacent a first surface of the disk,
wherein the internal structure of the retaining ring opposes a force applied at a second surface of the disk from within the venting structure.

12. The system of claim 11, wherein the internal structure comprises one or more spokes extending from a central hub to a circumference of the retaining ring.

13. The system of claim 11, wherein the internal structure of the retaining ring comprises an S-shaped structure or a triangular shaped central structure that extends across the retaining ring.

14. The system of claim 11, further comprising a plurality of fasteners for coupling the retaining ring and the disk to the endplate of the battery module.

15. The system of claim 11, wherein the disk comprises a ridge for securing the seal between the disk and the enclosure.

16. The system of claim 11, wherein the second surface of the disk faces toward the venting structure.

17. The system of claim 11, further comprising a sensor within the battery module, the sensor being operable to detect a change in pressure in the battery module that is indicative of damage to the disk.

18. The system of claim 11, further comprising a sensor within the venting structure, the sensor being operable to detect a change in pressure in the venting structure that is indicative of damage to the disk.

19. The system of claim 11, further comprising a wire disposed across the one-way pressure-rated burst disk device, the wire being operable to break in response to a change in pressure in the battery module that is indicative of damage to the disk.

20. The system of claim 11, further comprising at least one hinged spring mechanism that biases the disk toward the venting structure, wherein the at least one hinged spring is operable to transition the disk from a closed configuration to an open configuration in response to a change in pressure within the venting structure.
